(19) United States
(12) Patent Application Publication
(10) Pub. No.: US 2004/0193612 A1
(43) Pub. Date: Sep. 30, 2004

(54) System and method for testing, monitoring, and tracking distributed transactions using a search engine

(76) Inventor: William I. Chang, Saratoga, CA (US)

Correspondence Address: MacPherson Kwok Chen & Heid LLP, Suite 226, 1762 Technology Drive, San Jose, CA, 95110, US

(21) Appl. No.: 10/813,940

(22) Filed: Mar. 30, 2004

Related U.S. Application Data
(60) Provisional application No. 60/458,452, filed on Mar. 31, 2003.

(51) Int. Cl. G06F 17/30

(52) U.S. Cl. 707/10

(57) ABSTRACT

A distributed system of cooperative processes running on multiple processors of a computer network to accomplish a distributed transaction can be monitored and their execution traced by logging in a local resource of each processor records of execution data of the process on the processor. A search engine runs on each processor. The search engine retrieves corresponding records of execution data in response to a query. Such a query can be a distributed query issued to the processors simultaneously. The search engine may also index the records of execution data residing on the processor on which the search engine runs. By having a search engine run on each processor to manage local records of execution and retrieving the logged data using a distributed query, the present invention allows testing, monitoring and tracking of the distributed system during operation and subsequent to occurrence of a fault.

### CROSS-REFERENCE TO RELATED APPLICATIONS

The present application is related to and claims priority under 35 U.S.C. § 120 to provisional patent application, serial No. 60/458,452, entitled “Search Engine Applications: Testing, Monitoring, and Tracking Distributed Systems and Transactions,” filed on Mar. 31, 2003.

### BACKGROUND OF THE INVENTION

1. Field of the Invention

The present invention relates to the testing, tracing, monitoring, and analysis of distributed systems and applications. In particular, the present invention relates to applying search engine technology to the testing, tracing, monitoring and analysis of transactions that take place in a distributed system.

2. Discussion of the Related Art

A significant trend in information technology has been the development and wide deployment of distributed systems, applications, and services. At the same time and equally significantly, loosely coupled systems of components based on, or communicate using published open data formats (e.g., XML, Web Services) are being widely adopted for application interoperability and extensibility. The challenge faced by designers of distributed systems or such loosely coupled systems is that of ensuring that the systems work. It is very difficult to develop, integrate, and debug a system or application whose components run on different processors. What may appear to work on isolated instances of data during testing, tend very often to fail when the data volume is increased. For such a system or application, it is difficult to conduct a stress test in which software and hardware components are placed in and out of service to see how the system as a whole would respond to partial breakdowns. Such a stress test is difficult because of the enormous difficulty in being able to simulate all conceivable realistic situations that the system will encounter in operation. As a result, complex distributed systems and applications are often delivered late and remain unreliable, even after incurring high cost overruns.

After deployment of such systems, operational problems inevitably arise. Because the system typically cannot be placed in a “debug mode” during operation and still reasonably deliver acceptable performance, the prior art does not provide a way to trace a problem during or after system failure. Without an ability to trace the distributed system's operation, the origin and the evolution of a problem cannot be isolated. Even if a system is taken down, the conditions of the distributed system that led to the errors may not be replicable. As a result, debugging a distributed system post-deployment can be extremely risky and costly.

Thus, what is needed is an efficient and non-intrusive way to monitor and play-back the detailed workings of a distributed system or application that can be continuously run during operation of the system or application. Typical approaches used in the prior art include sending log messages over the computer network to a dedicated server or database, or logging (“print”) to a file. However, both approaches tend to create serious performance bottlenecks in network traffic and/or I/O if enough information is to be saved. In addition, any data thus gathered often come from components built at different times using different technologies, and reside on different servers. It is time-consuming or often impossible to collect and to integrate such data into a useful picture of the distributed system during the critical moments of failure. Even worse, transactions increasingly span beyond the local computer network. Inter-departmental integration of enterprise applications often poses difficult problems, especially when the applications have components in different sites. As companies grow through mergers and acquisitions, distributed transactions become even more prevalent. Finally, the internet (and Web Services in particular) enables distributed transactions to routinely go beyond corporate boundaries. When a transaction fails to complete, how does one detect and trace the problem in order to correct it? How does one audit a transaction trail so as to ensure correct accounting and payments? Those are questions that the prior art does not provide answers to.

### SUMMARY

Embodiments of the present invention address the key problems that plague distributed systems and transactions by using distributed search engines. The key problems include (1) lack of knowledge of the conditions under which components fail; (2) lack of an ability to trace the origin and evolution of a problem; and (3) the prohibitive cost of providing a useful operational audit trail. The present application is applicable to distributed systems that carry out transactions across multiple servers, departmental applications, and business boundaries over a computer network, such as LAN or the internet (or in combination). Such systems are prevalent in business or manufacturing process monitoring, and quality assurance applications.

According to one embodiment of the present invention, a network of local search engines each residing on a processor, or executing as an adjunct to a software component of the distributed system, receives a continuous stream of detailed log data from software running on that server or resulting from operation of the software component. The log data may be translated into a standard published data format (e.g., XML), and then indexed by the search engine (which may also manage the log files). Under this arrangement, a complete record of a transaction can be tracked during or after operation through issuing a distributed search query keyed on, for example, a transaction identifier (or a customer identifier). Thus, a failed transaction can be reconstructed and its underlying problem diagnosed.

The present invention is better understood upon consideration of the detailed description below and the accompanying drawings.

### BRIEF DESCRIPTION OF THE DRAWINGS

FIG. 1 shows a distributed system 100 with the tracking, monitoring and testing capabilities, according to one embodiment of the present invention.

FIG. 2 shows a scheme that can be used to provide continuous indexing with indices stored both in memory and on disk.

FIG. 3 shows index 301 being stored on disk in order of key values, and helper table 302 for greater access efficiency.

FIG. 4 shows an example of a sample log data record 400.

FIG. 5 summarizes the management tasks for storing and indexing log files at two consecutive time periods.

FIG. 6 illustrates an example of diagnosing a distributed system using a distributed search in accordance with one embodiment of the present invention.

### DETAILED DESCRIPTION OF THE PREFERRED EMBODIMENTS

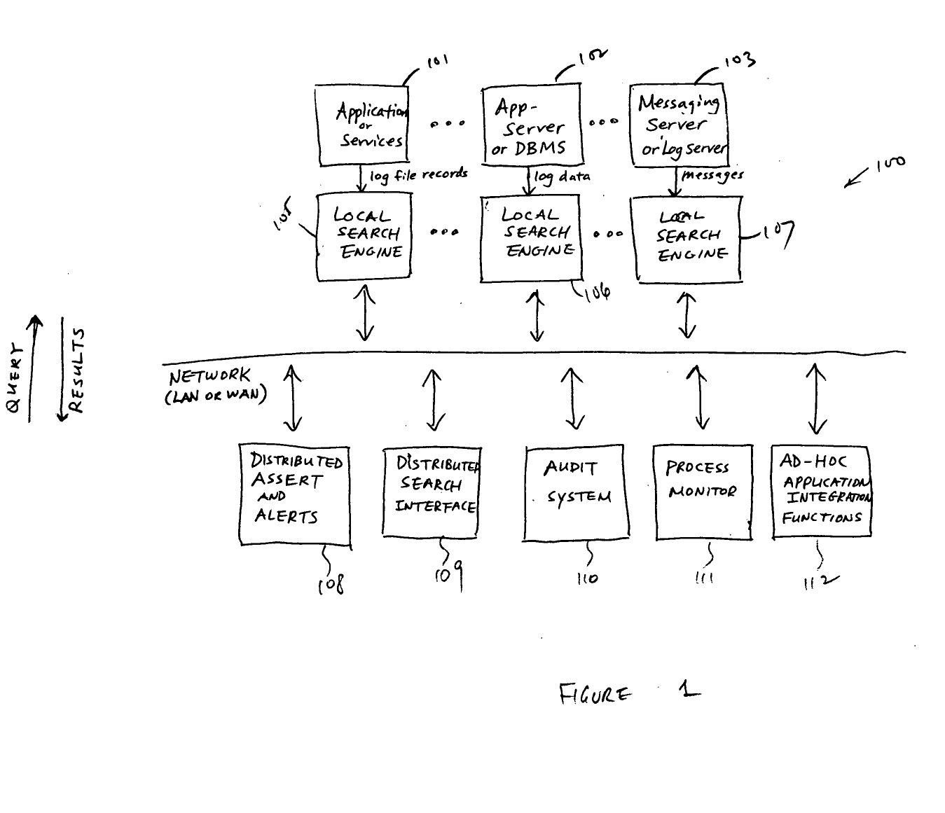

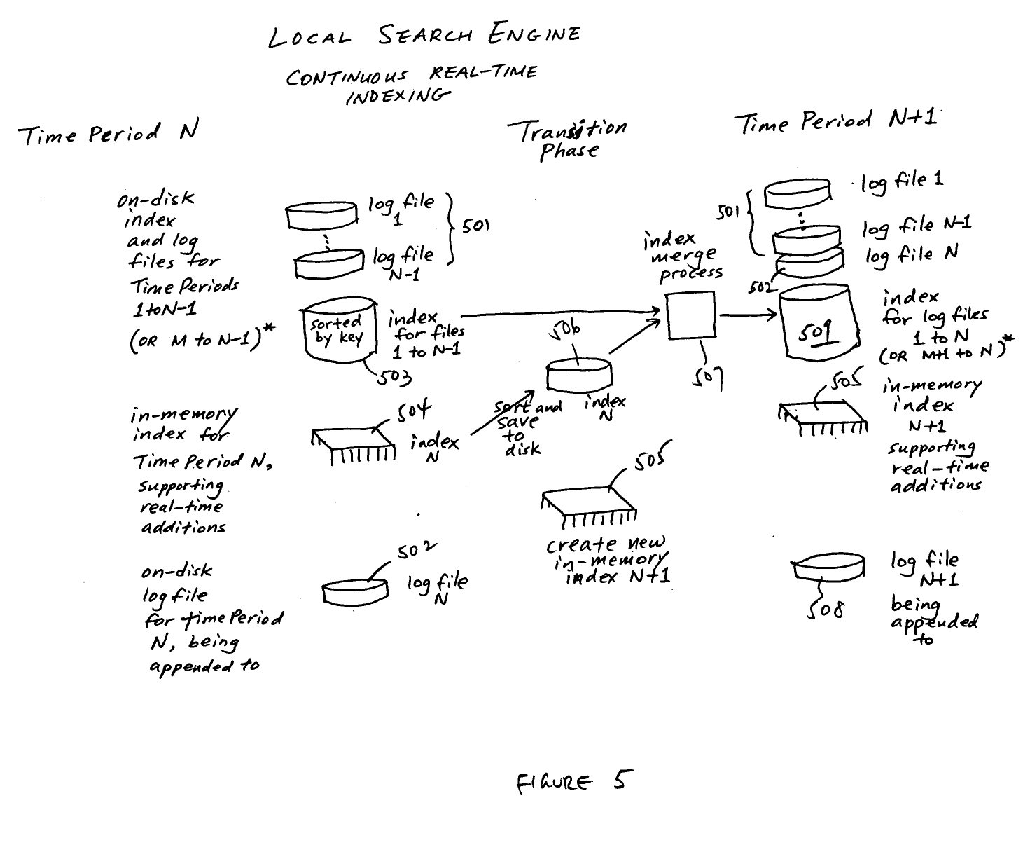

FIG. 1 shows a distributed system 100 with the tracking, monitoring and testing capabilities, according to one embodiment of the present invention. Components 101-103 represent hardware or software components of distributed system 100, performing such tasks as, for example, running an application or service, an application server, or a messaging system. In each instance, each software or hardware component writes a stream of log entries, as a record of transactions performed by the hardware or software component, which is sufficiently detailed to allow subsequent diagnosis of any local problem, or non-local inconsistency, that may have occurred during operation. Local search engines 105-107 are provided on the same processor as the hardware or software component to allow local retrieval and indexing of the logged information. For efficiency and functionality, the details being logged and indexed can be adjusted, preferably at run-time, either at a software component or at a search engine that receives the logged records. An example of a sample log data record 400 is shown in FIG. 4.

To keep all the servers of the distributed system approximately synchronized “on the same clock”, a heartbeat pulse message is periodically sent throughout the entire system and logged, so that events occurring roughly simultaneously in the computer network can be compared and ordered using the heartbeat and local clocks. Further, the operating system monitor on each server also logs data describing the overall workload and health of the operating system and hardware at which the hardware or software component of the distributed system resides. If any software component does not adequately or proficiently log its data (e.g. when the log files gets too large), the local search engine can take on that added responsibility of archiving and renewing log files. Any “application server” or DBMS 102 that runs multiple components in a virtual distributed environment, or any “message queue server” or log server 103 should also have its log data incorporated into a local search engine. Preferably, all the necessary data to describe the input, output, side-effects, and internal-state/intermediate-steps (if complex) of each software component or object should be logged. Search engines 105-107 are preferably high-throughput real-time search engines. The search engine on each processor indexes the log streams from that processor, possibly translating the log entries into a standard format such as XML. The indexing is done in a way that allows ad-hoc text (keyword) queries and structured (“fielded”) queries to be used for retrieval.

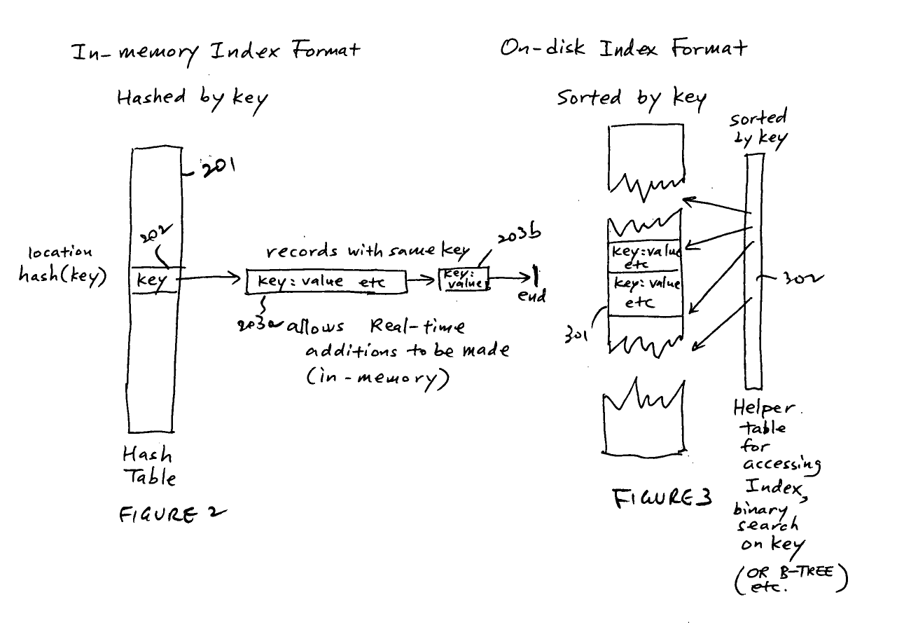

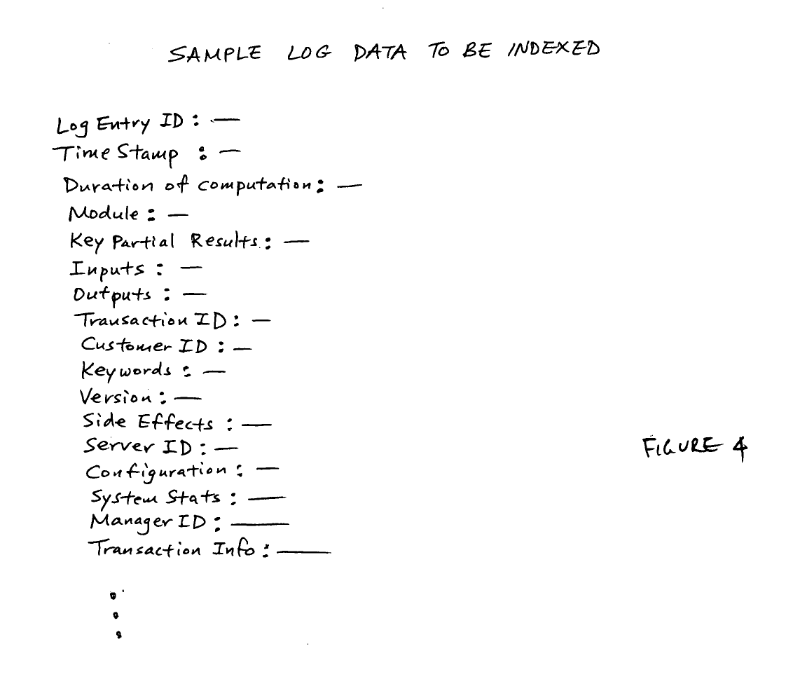

As the amount of logged data at each search engine is expected to be large, the index task is run continuously, with additional indices inserted into a set of existing indices. FIGS. 2 and 3 show a scheme that can be used to provide continuous indexing with indices stored both in memory and on disk. As shown in FIG. 2, indexing can be performed using hash table 201 in memory. As each record to be indexed is read into memory, the value of a key associated with the record is hashed, and a pointer to the record is associated with an entry of the hash table. A number of records (even with different key values) may be associated with a single entry 202 in the hash table. As shown in FIG. 2, records 203a-203b that are hashed to the same entry 202 of hash table 201 can be maintained in a linked list, to allow easy insertions. Having multiple internal indices per search engine allows the search engine to continue to receive and index log entries while post-processing prior indices. For example, the indices in memory (not including the one receiving new logs) can be merged into a single index file on disk. When an index is deemed “full”, a new memory-based index is created to take over the task of indexing new entries. This technique can be used for storing and managing both indices and the log entries. In time, the indices in memory are written on disk to be stored for a longer term.

FIG. 3 shows index 301 being stored on disk in order of key values. In addition, a second level of indices called helper tables, such as helper table 302, can be provided to allow rapid access to specific ranges of key values. Helper table 302 can be accessed through binary search, or can be organized as a B-tree, as known to those skilled in the art. To merge the indices in memory with the indices on hard disk, the memory indices are sorted by key values if needed, and the disk indices are read into memory sequentially by key values. The indices records are then merged in order of key values and written back onto disk. In some embodiment, a record may be assigned a lifetime beyond which the record is deemed expired. Expired records are simply skipped at the time of merge.

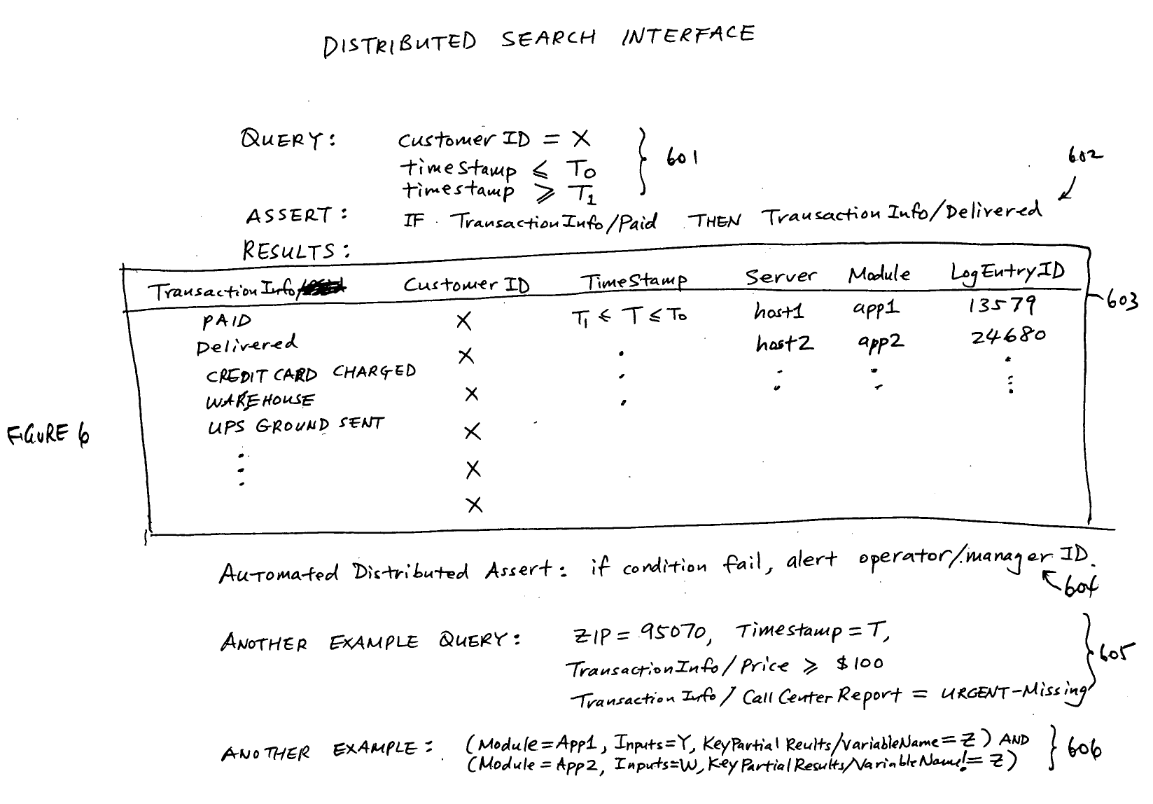

FIG. 5 summarizes the management tasks for storing and indexing log files at two consecutive time periods. As shown in FIG. 5, at time period N, the log files 501, corresponding to log data collected between the first time period and time period N−1, inclusive, are stored as closed files on disk. At the same time, open file 502, which is the log file for time period N, adds data records as they are generated. Index 503 for log data records collected between the first time period and time period N−1 is stored on disk. A process for indexing runs in memory and maintains index 504, which indexes log data records that are received into log data file 502 during time period N. At the end of time period N, a new in-memory index 505 is created to index log data records that are to be received into log file 508. File 508 is created for receiving log data records during time period N+1. The in-memory index created during time period N is written onto disk into index file 506. At the beginning of time period N+1, index files 503 and 506 are merged. If the system restricts searching to P previous time periods, only the indices corresponding to time periods N−1−P to N−1 are merged into index file 509. During time period N+1, log data records are received into file 508 and the in-memory index 505 is created for indexing log data records received into file 508 during that time period.

When there is a need to examine a distributed transaction, such as to trace an improperly executed (“failed”) transaction, a distributed search is issued from a client (e.g., referring back to FIG. 1, through distributed search interface 109). The distributed query is issued to all or some of search engines 105-107. The returned results of all responding search engines are merged and sorted according to specified attributes such as by (synchronized) timestamps, or transaction identifiers. In some instances, a graphical user interface, e.g., a “browser” on the client, displays such query results. In the case of diagnosing a failed transaction, the trail of logged events leading up to the error in each processor involved in the transaction can be recovered and sorted, and all relevant logged data checked. FIG. 6 illustrates an example of diagnosing a distributed system using a distributed search in accordance with one embodiment of the present invention. As shown in FIG. 6, a user issues a distributed query 601 to specify retrieval of log data records corresponding to “Customer ID=X” that are created between time periods T₀ and T₁, inclusive. In addition, the system may support a set of programmed rules (“asserts”) that determine if certain specified conditions are met by the distributed data sets. Thus, in FIG. 6, an assert 602 is issued to the effect that, if a “paid” value is found in the “TransactionInfo” field of a log data record in the results from the query, there should be another data record in the same results in which the “TransactionInfo” field has a value “delivered.” FIG. 6 shows result 603 returned from query 601, assembled by a search client (possibly an automated quality-control or audit subsystem performing spot checks), which combines and sorts the query results from all the search engines, and reconstructs a time-sequence of the transaction component events, with associated data. As shown in FIG. 6, the assertion was successful. The user may also specify (604) that the system reports a failure of assertion 602 to an operator/manager of a specified ID.

Other example queries 605 and 606 are also shown in FIG. 6. In query 605, for example, records having fields of specified values or range of values are searched. In query 606, records containing inconsistent results are being looked for. Thus, transactions of a certain type, during a certain time span, or containing certain keywords can be similarly retrieved through appropriate distributed search queries.

Thus, since a local search engine (or “database” that indexes) searches detailed local log data, no additional network messaging overhead is incurred, except for the query and the response. The detailed log data allows a transaction to be traced across the distributed system (possibly spanning more than one department or company) even after a problem has already occurred. The present invention is not merely a network of conventional databases, which is unsuitable for use in testing, monitoring or tracking of a distributed transaction, due to inefficiencies, and administration and maintenance difficulties. The search engine technology described herein has much higher indexing throughput especially suited to continuous, real-time operation with no downtime, and allows a broader set of queries containing both free-text and controlled vocabularies to be issued. The present invention is applicable even if the multiple search engines are “virtual”, e.g. the log data are transported to one or more collection points (assuming sufficient network bandwidth) to be searched by one or more search engine processes on the same processor.

The results achieved by the present invention are unexpected, as these known hard problems (distributed debugging and transaction tracking) are not normally thought of as search engine applications. A method according to the present invention can also be applied to the problems of monitoring business or manufacturing processes (e.g., process monitor 111, or audit system 110), so long as log data are available. By providing both developers and business users with a global integrated view of distributed transactions that is threaded and transparent, a method of the present invention improves quality of software and increases visibility and efficiency of businesses at every level.

The distributed search engines also form the basis of a specialized applications development platform, pulling data directly out of indexed log files. Support and analytical applications are especially suited, as are payment or audit systems. In the task of enterprise application integration when “bridge” software between certain components is not available, the distributed search engines working on log data can be useful for ad-hoc integration (e.g., ad-hoc integration module 112). Finally, many office or desktop applications produce data or log files that can be translated and indexed by a search engine. Through querying such office or desktop search engines in combination with enterprise transaction data or WWW search, it is possible to add layered functionality (e.g. through a web browser) without having to modify or directly interface with an application's code. The “search results” may be hyperlinks to additional data or functionality.

The above-detailed description is provided to illustrate specific embodiments of the present invention and is not intended to be limiting. Numerous variations and modifications within the scope of the present invention are possible. The present invention is set forth in the following claims.

I claim:

1. A distributed system comprising:
a plurality of cooperative processes running on a plurality of processors of a computer network to accomplish a distributed transaction, each process logging in a local resource records of execution; and
a search engine running on each of the plurality of processors, each search engine retrieving corresponding records of execution in response to a query.

2. A distributed system as in claim 1, wherein the query is issued to the processors as a distributed query.

3. A distributed system as in claim 1, wherein the query is issued from a client performing debugging of the distributed system.

4. A distributed system as in claim 1, wherein the query is issued from a client performing an audit trail of distributed transactions.

5. A distributed system as in claim 1, wherein the query is issued from a client performing monitoring of a manufacturing process.

6. A distributed system as in claim 1, wherein the query is issued from a client performing monitoring of a business process.

7. A distributed system as in claim 1, wherein the query is issued from a client performing application integration.

8. A distributed system as in claim 1, wherein the query is issued from a client which merges the results received from search engines responding to the query.

9. A distributed system as in claim 8, wherein the client applies program rules on the merged results to determine correct operation of the distributed system.

10. A distributed system as in claim 1, wherein each search engine generates indices to the records of execution.

11. A distributed system as in claim 10, wherein the indices is created in memory.

12. A distributed system as in claim 11, wherein a portion of the indices are stored onto disk after a specified time period.

13. A distributed system as in claim 11, wherein the indices in memory and the portion of the indices stored onto disk are merged from time to time.

14. A method for analyzing a distributed system, comprising:
running a plurality of cooperative processes on a plurality of processors of a computer network to accomplish a distributed transaction, each process logging in a local resource records of execution; and
running a search engine on each of the plurality of processors, each search engine retrieving corresponding records of execution in response to a query.

15. A method as in claim 14, wherein the query is issued to the processors as a distributed query.

16. A method as in claim 14, wherein the query is issued from a client performing debugging of the distributed system.

17. A method as in claim 14, wherein the query is issued from a client performing an audit trail of distributed transactions.

18. A method as in claim 14, wherein the query is issued from a client performing monitoring of a manufacturing process.

19. A method as in claim 14, wherein the query is issued from a client performing monitoring of a business process.

20. A method as in claim 14, wherein the query is issued from a client performing application integration.

21. A method as in claim 14, wherein the query is issued from a client, further comprising merging in the client the results received from search engines responding to the query.

22. A method as in claim 21, further comprising applying in the client program rules on the merged results to determine correct operation of the distributed system.

23. A method as in claim 14, further comprising generating in each search engine indices to the records of execution.

24. A method as in claim 23, wherein the indices are created in memory.

25. A method as in claim 24, further comprising storing a portion of the indices onto disk after a specified time period.

26. A method as in claim 25, further comprising merging, from time to time, the indices in memory and the portion of the indices stored onto disk.
